(19) United States
(12) Patent Application Publication
(10) Pub. No.: US 2025/0240358 A1
(43) Pub. Date: Jul. 24, 2025

(54) COMMUNICATION DEVICE

(71) Applicant: DENSO CORPORATION, Kariya-city (JP)

(72) Inventors: TETSUO NAKAGAWA, Kariya-city (JP); NAOYA KOBAYASHI, Kariya-city (JP); TAICHI ITAGAWA, Kariya-city (JP)

(21) Appl. No.: 19/022,097

(22) Filed: Jan. 15, 2025

(30) Foreign Application Priority Data
Jan. 19, 2024 (JP) 2024-006752

(51) Int. Cl. H04L 69/22; H04L 67/12; H04L 69/321; H04L 69/324

(52) U.S. Cl. CPC H04L 69/22; H04L 67/12; H04L 69/321; H04L 69/324

(57) ABSTRACT

A communication device includes a circuit unit implemented by hardware circuits and a core unit implemented by a CPU and a non-transitory tangible storage medium storing a program. The circuit unit executes, in hardware manner, a processing of lower layer protocol. The core unit is configured to execute, in software manner, a processing of upper layer protocol. The circuit unit executes a part or all of the upper layer protocol in hardware manner instead of the core unit. The circuit unit refers to protocol assignment information included in a reception frame, and assigns, according to a preset allocation rule, the reception frame to a first reception path without performing offload processing or a second reception path by performing offload processing. The protocol assignment information indicates (i) a type of the upper layer protocol or (ii) a type or characteristics of data to be processed by the upper layer protocol.

### CROSS REFERENCE TO RELATED APPLICATION

The present application claims the benefit of priority from Japanese Patent Application No. 2024-006752 filed on Jan. 19, 2024. The entire disclosure of the above application is incorporated herein by reference.

### TECHNICAL FIELD

The present disclosure relates to a communication device that uses multiple different communication protocols.

### BACKGROUND

There has been known an offload technology in which offload is performed by switching communication paths using Quality of Service (QOS) tag information at the time of reception as traffic characteristics.

### SUMMARY

A communication device includes a circuit unit implemented by hardware circuits and a core unit implemented by a central processing unit and a non-transitory tangible storage medium storing a program. The circuit unit executes, in a hardware manner, a processing of a lower layer protocol, and the lower layer protocol is a communication protocol including a data link layer. The core unit, by executing the program stored in the non-transitory tangible storage medium, is configured to execute, in a software manner, a processing of an upper layer protocol, and the upper layer protocol utilizes the lower layer protocol. The circuit unit executes a part or all of the upper layer protocol in a hardware manner instead of the core unit as an offload processing. The circuit unit refers to protocol assignment information included in a reception frame, and assigns, according to an allocation rule set in advance, the reception frame to a first reception path, which does not execute the offload processing, or a second reception path, which executes the offload processing. The protocol assignment information is information included in the reception frame and indicates at least one of (i) a type of the upper layer protocol or (ii) a type or characteristics of data to be processed by the upper layer protocol.

### BRIEF DESCRIPTION OF DRAWINGS

Objects, features and advantages of the present disclosure will become apparent from the following detailed description made with reference to the accompanying drawings. In the drawings:

FIG. 1 is a block diagram showing a configuration of an in-vehicle system;

FIG. 2 is a block diagram showing a functional configuration of a first communication processing unit;

FIG. 3 is a diagram showing a configuration example of Ethernet frame and an operation example of PCP;

FIG. 4 is a diagram showing configurations of an IP header, a UDP header, and a TCP header;

FIG. 5 is a diagram showing an example of setting an allocation rule using PCP;

FIG. 6 is a diagram showing a configuration example of UDP frame and an operation example of UDP port;

FIG. 7 is a diagram showing an example of setting an allocation rule using UDP port number;

FIG. 8 is a diagram showing a configuration of a SOME/IP frame;

FIG. 9 is a diagram showing a configuration example of SOME/IP-SD packet and characteristic information of transmission data and reception data;

FIG. 10 is a diagram showing an example of setting allocation rules using characteristic information of transmission data and reception data; and

FIG. 11 is a diagram showing a configuration of AVTP frame and excerpt of definition of subtype.

### DETAILED DESCRIPTION

In offload processing, instead of switching communication path, a process performed in software manner may be switched to be executed in hardware manner. For example, when a communication protocol for high-bandwidth communication is implemented in software manner, the software process consumes a large amount of CPU resource. When the CPU resource allocated to protocol processing is insufficient, the insufficient resource may cause a restriction on communication speed. Thus, for this kind of communication protocol, offload may be considered. However, it is difficult to implement all of the complex controls of communication protocol, which are implemented in software manner, using hardware configuration.

According to an aspect of the present disclosure, a communication device includes a lower layer protocol processing unit, an upper layer protocol processing unit, an offload processing unit, and a reception offload filter.

The lower layer protocol processing unit executes, in a hardware manner, a processing of a lower layer protocol. The lower layer protocol is a communication protocol including a data link layer. The upper layer protocol processing unit executes, in a software manner, a processing of an upper layer protocol. The upper layer protocol is a communication protocol of an upper layer that utilizes the lower layer protocol. The offload processing unit executes a part or all of the upper layer protocol in a hardware manner instead of the upper layer protocol processing unit. The reception offload filter refers to protocol assignment information included in a reception frame received by the lower layer protocol processing unit, and assigns, according to an allocation rule set in advance, the reception frame to a first reception path, which does not use the offload processing unit, or a second reception path, which uses the offload processing unit. The protocol assignment information is information included in the reception frame and indicates at least one of a type of the upper layer protocol and a type or characteristics of data to be processed by the upper layer protocol.

With the above configuration, it is possible to select and execute an appropriate offload processing for each type of upper layer protocol or for each type or characteristic of data processed by the upper layer protocol. As a result, the processing load required for software processing of the upper layer protocol can be properly reduced.

The following will describe embodiments of the present disclosure with reference to the drawings.

### 1. Overall Configuration

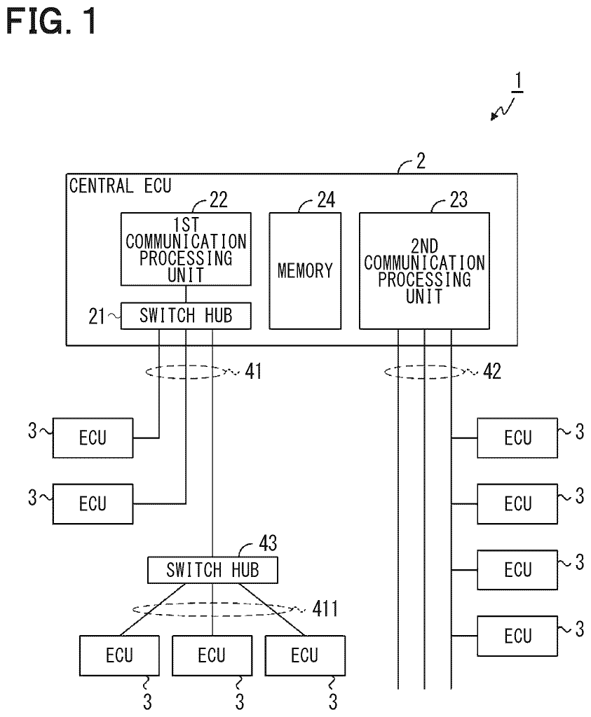

An in-vehicle system 1 shown in FIG. 1 includes a central electronic control unit (hereinafter, referred to as central ECU) 2, multiple zone ECUs 3, and an in-vehicle communication network 4. The ECU is an abbreviation for an electronic control unit.

The central ECU 2 controls the multiple zone ECUs 3 and performs a coordinated control of the entire vehicle. The central ECU 2 includes a switch hub 21, a first communication processing unit 22, a second communication processing unit 23, and a memory 24. The central ECU 2 may be configured in part or in whole by a SoC. The SoC is an abbreviation for system on a chip.

The switch hub 21 has multiple ports. The in-vehicle communication network 4 includes communication lines (hereinafter, referred to as Ethernet transmission lines) 41, and the Ethernet transmission lines 41 are connected to the multiple ports of the switch hub 21. The multiple Ethernet transmission lines 41 form a star network with the switch hub 21 as the center. Each Ethernet transmission line 41 is connected to one or more zone ECUs 3. When connecting multiple zone ECUs 3 to one port, the Ethernet transmission line 41 may be branched by connecting a switch hub 43, and one zone ECU 3 may be connected to each of the multiple branched Ethernet transmission lines 411. In each Ethernet transmission line 41 and 411, communication is carried out in accordance with the Ethernet protocol. Ethernet is a registered trademark. The switch hub 21 executes a process for allocating a destination of Ethernet frame according to a MAC address of the Ethernet frame.

The first communication processing unit 22 processes a reception frame, which is received via the switch hub 21 and is destined to the central ECU 2. Details of the first communication processing unit 22 will be described in detail later.

The second communication processing unit 23 includes multiple CAN transceivers, each of which is individually connected to a CAN bus 42. The Can bus 42 is included in the in-vehicle communication network 4. CAN is an abbreviation for Controller Area Network. CAN is a registered trademark. One or more zone ECUs 3, which perform data communication via the CAN bus 42, are connected to each CAN bus 42. Communication is carried out in accordance with CAN protocol on the CAN bus 42. The second communication processing unit 23 relays CAN frames transmitted and received via the CAN bus 42, and processes data extracted from the CAN frames.

The first communication processing unit 22 and the second communication processing unit 23 each executes a protocol conversion process for converting an Ethernet frame into a CAN frame and converting a CAN frame into an Ethernet frame.

The zone ECU 3 connected to the Ethernet transmission line 41, 411 has the same functions as the first communication processing unit 22, except for the protocol conversion function. The zone ECU 3 connected to the CAN bus 42 includes one CAN transceiver, and has the same functions as the second communication processing unit 23, except for the protocol conversion function and the relay function for relaying a frame to the CAN buses 42.

### 2. First Communication Processing Unit

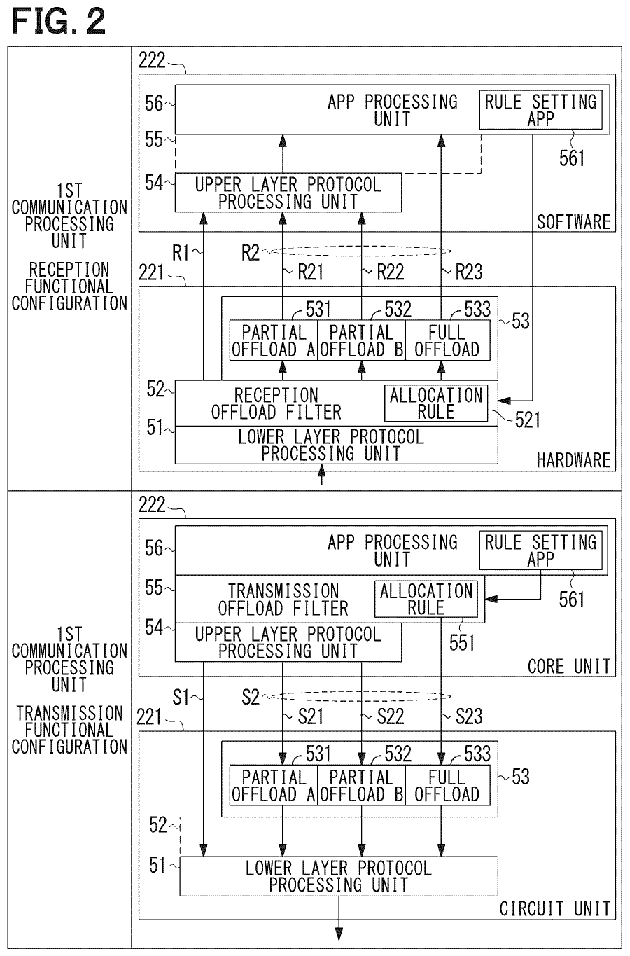

As shown in FIG. 2, the first communication processing unit 22 includes a circuit unit 221 and a core unit 222.

The circuit unit 221 is provided by hardware circuits or integrated circuits, and includes, as functional blocks implemented by the hardware circuits, a lower layer protocol processing unit 51, a reception offload filter 52, and an offload processing unit 53.

The core unit 222 includes a central processing unit (CPU), a read only memory (ROM), a random access memory (RAM), and the like. Various functions of the core unit 222 are implemented by the CPU executing a program stored in a non-transitory tangible storage medium. For example, the ROM corresponds to the non-transitory tangible storage medium storing the program. By executing the program, a method corresponding to the program is executed.

The core unit 222 includes an upper layer protocol processing unit 54, a transmission offload filter 55, and an application processing unit 56, as functional blocks implemented by the CPU executing a program stored in the ROM. Application is also referred to as app.

The operation of each of the functional blocks 51 to 56 included in the first communication processing unit 22 will be described for the reception process and transmission process, separately. The communication protocol adopted by the lower layer protocol processing unit 51 is referred to as a lower layer protocol, and the communication protocol adopted by the upper layer protocol processing unit 54 is referred to as an upper layer protocol. The upper layer protocol is a communication protocol used in upper layer and utilizes the lower layer protocol. The lower layer protocol is a protocol corresponding to the second layer of the OSI reference model (that is, the data link layer), and the upper layer protocol is a protocol corresponding to the third layer or higher layer in the OSI reference model.

The operation of the first communication processing unit 22 in reception process will be described.

The lower layer protocol processing unit 51 receives a communication frame (hereinafter referred to as a reception frame) destined to the central ECU 2 via the switching hub 21. The lower layer protocol processing unit 51 executes a process using header information (that is, PCI) included in the reception frame (that is, PDU of lower layer protocol). PDU an abbreviation of Protocol Data Unit. PCI an abbreviation of Protocol Control Information. The actual information included in the PDU together with the PCI and passed to the upper layer protocol is referred to as SDU. SDU is an abbreviation of Service Data Unit.

When the lower layer protocol is an Ethernet protocol, the lower layer protocol processing unit 51 may perform error detection process using FCS, and provides, to the reception offload filter 52, the reception frame from which no error is detected. FCS is an abbreviation of Frame Check Sequence.

The reception offload filter 52 refers to the protocol assignment information included in the PDU of the lower layer protocol (hereinafter referred to as lower layer PDU), and selects the reception path to be used when providing data to the upper layer protocol processing unit 54 in accordance with a preset allocation rule 521, which is set in advance.

The protocol assignment information is information capable of identifying the type of upper layer protocol, the type and characteristics of data to be processed by the upper layer protocol, and the like.

The reception paths include a first reception path R1 and one or more second reception paths R2. The first reception path R1 is a path that provides the SDU (that is, the PDU of upper layer protocol) included in the lower layer PDU to the upper layer protocol processing unit 54 without going through the offload processing unit 53. In this case, the upper layer protocol processing unit 54 executes the whole process of upper layer protocol in software manner. The second reception path R2 is a path that provides the PDU of upper layer protocol to the upper layer protocol processing section 54 via the offload processing unit 53. In this case, among the process of upper layer protocol, the upper layer protocol processing unit 54 executes remaining process other than the process performed by the offload processing unit 53.

The allocation rule 521 is information that associates a value of protocol assignment information with a reception path to be selected. The allocation rules 521 may be set to a fixed value, or may be configured such that the settings can be changed according to an instruction from a user application (e.g., a rule setting application 561) executed by the application processing unit 56.

The offload processing unit 53 includes processing units the number of which is the same as the number of the second reception paths R2. In the present embodiment, the offload processing unit 53 includes a first processing unit 531, a second processing unit 532, and a third processing unit 533.

The first processing unit 531 processes, in hardware manner, a part of the upper layer protocol adopted by the upper layer protocol processing unit 54, and outputs a processing result to the upper layer protocol processing unit 54 together with the PDU of the upper layer protocol. Hereinafter, for differentiating purpose, the processing in the first processing unit 531 is referred to as partial offload A, and the second reception path R2 that uses the first processing unit 531 is also referred to as R21.

The second processing unit 532 processes, in hardware manner, a part of the upper layer protocol, which is at least partially different from the processing target of the first processing unit 531. The second processing unit 532 outputs a processing result to the upper layer protocol processing unit 54 together with the PDU of the upper layer protocol. Hereinafter, for differentiating purpose, the processing in the second processing unit 532 is referred to as partial offload B, and the second reception path R2 that uses the second processing unit 532 is also referred to as R22.

The third processing unit 533 executes whole process of the upper layer protocol in hardware manner, and outputs a processing result to the application processing unit 56. The application processing unit includes a user application or the like that performs communication using the upper layer protocol. Hereinafter, the process executed by the third processing unit 533 is also referred to as a full offload, and the second reception path R2 that uses the third processing unit 533 is also referred to as R23.

The upper layer protocol processing unit 54 implements the upper layer protocol by using the PDU of upper layer protocol and the processing result obtained by the offload processing unit 53. The PDU of upper layer protocol and the processing results are input from the first reception path R1 or the second reception path R21, R22. The upper layer protocol processing unit 54 outputs the SDU of the upper layer protocol to the application processing unit 56.

The transmission offload filter 55 is not used in reception process by passing through the transmission offload filter 55.

The operation of the first communication processing unit 22 in transmission process will be described.

The application processing unit 56, which performs communication using the upper layer protocol, outputs a transmission request to the transmission offload filter 55. The transmission request indicates information necessary for generating an upper layer PDU. The transmission request includes information necessary for generating a transmission frame to be transmitted from the lower layer protocol processing unit 51 in response to the transmission request. Specifically, in addition to the SDU of upper layer protocol, various information used to generate the PCI of upper layer protocol and the PCI of lower layer protocol is included in the transmission request. The various information also includes protocol assignment information.

When the transmission request is input from the application processing unit 56, the transmission offload filter 55 refers to the protocol assignment information included in the transmission request and selects a transmission path to be used in transmission of an upper layer PDU to the lower layer protocol processing unit 51 in accordance with an allocation rule 551 set in advance.

The allocation rule 551 is information that associates a value of protocol assignment information with a transmission path to be selected. The allocation rule 551 has the same contents as the allocation rule 521 used in the reception offload filter 52. The allocation rule 551 does not necessarily have to be the same as the allocation rule 521 used in the reception offload filter.

The transmission paths include a first transmission path S1 and one or more second transmission paths S2. The first transmission path S1 is a path that provides an upper layer PDU (i.e., an SDU of lower layer protocol) to the lower layer protocol processing unit 51 without going through the offload processing unit 53. The second transmission path S2 is a path that provides an upper layer PDU to the lower layer protocol processing unit 51 via the offload processing unit 53.

The first processing unit 531 outputs the processing result of partial offload A (i.e., hardware process) to the lower layer protocol processing unit 51 together with the processing result of upper layer protocol by the upper layer protocol processing unit 54 (i.e., software process) other than the partial offload A. Hereinafter, the second transmission path S2 that uses the first processing unit 531 is also be referred to as S21.

The second processing unit 532 outputs the processing result of partial offload B (i.e., hardware processing) to the lower layer protocol processing unit 51 together with the processing result of upper layer protocol by the upper layer protocol processing unit 54 (i.e., software processing) other than the partial offload B. Hereinafter, the second transmission path S2 that uses the second processing unit 532 also referred to as S22.

The third processing unit 533 outputs the processing result of upper layer protocol executed by the upper layer protocol processing unit 54 to the lower layer protocol processing unit 51. Hereinafter, the second transmission path S2 that uses the third processing unit 533 is also referred to as S23.

The lower layer protocol processing unit 51 generates a lower layer PDU using the upper layer PDU supplied via the first transmission path S1 and the second transmission path S2 as the lower layer SDU, and transmits the generated lower layer PDU via the switch hub 21 to the Ethernet transmission line 41 linked to the destination MAC address. The lower layer PDU generated by the lower layer protocol processing unit 51 corresponds to an Ethernet frame.

The reception offload filter 52 is not used during transmission and is passed through.

The application processing unit 56 may include a rule setting application 561 as one of the user applications. The rule setting application 561 acquires pre-transmission information required for setting the allocation rule 521, 551 through communication using the upper layer protocol, and generates the allocation rule 521, 551 in accordance with the pre-transmission information. The rule setting application 561 sets and updates the allocation rules 521, 551 to be used in the reception offload filter 52 and the transmission offload filter 55 using the generated allocation rules 521, 551.

### 3. EMBODIMENTS

### 3.1 First Embodiment

The following will describe a case in which UDP/IP and TCP/IP are used as upper layer protocols, an Ethernet protocol is used as a lower layer protocol, and information included in the header of Ethernet frame is used as the protocol assignment information. UDP is an abbreviation for User Datagram Protocol. TCP is an abbreviation for Transmission Control Protocol. IP is an abbreviation for Internet Protocol.

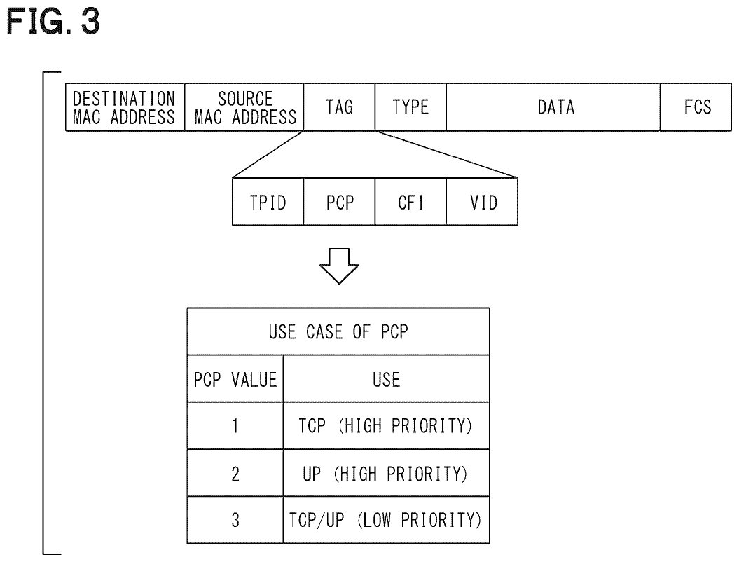

The Ethernet frame complies with the DIX standard defined in IEEE 802.1Q. As shown in FIG. 3, an Ethernet frame includes a header, a payload, and a trailer. The header includes fields for setting destination MAC address, source MAC address, tag, type, and the like. The payload stores the upper layer PDU. The trailer stores FCS. The FCS is data added to check whether an error is occurred in the payload data.

The tag included in the header has fields for setting TPID, PCP, CFI, and VID. TPID is an abbreviation for Tag Protocol Identifier. TPID is a tag protocol identifier, and a default value indicating tagged Ethernet is set as TPID. PCP is an abbreviation for Priority Code Point. PCP indicates priority information. CFI is an abbreviation for Canonical Format Identifier. CFI indicates an identifier of canonical format. VID is an abbreviation for VLAN Identifier. VID is an identifier for identifying a VLAN.

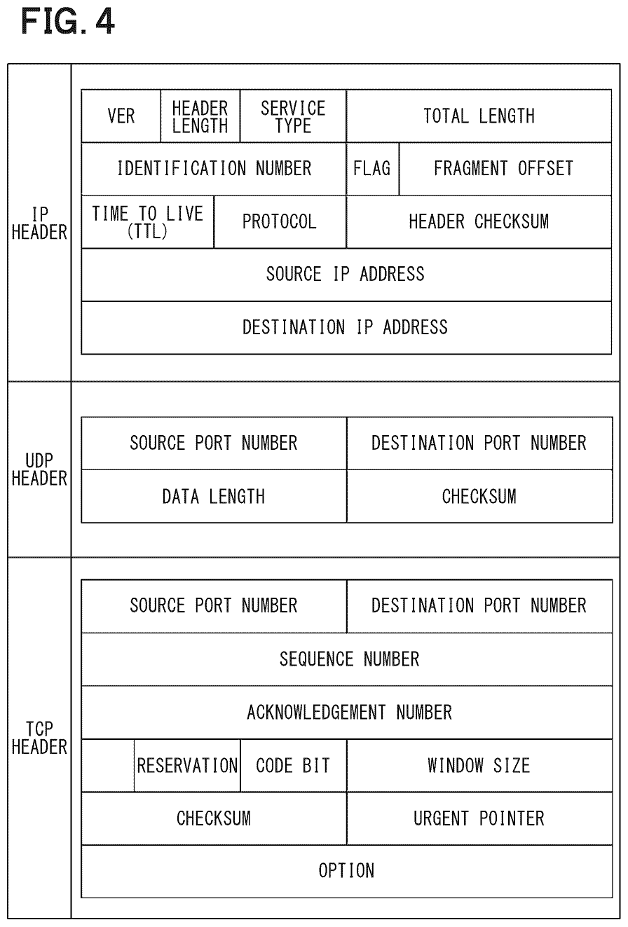

As shown in FIG. 4, the IP header includes fields for setting Ver, Header Length, Service Type, Total Length, Identification Number, Flag, Fragment Offset, TTL (Time to Live), Protocol, Header Checksum, Source IP Address, Destination IP Address, and the like.

The UDP header includes fields for setting source port number, destination port number, data length, checksum, and the like.

The TCP header includes fields for setting source port number, destination port number, sequence number, acknowledgement number, reservation, code bit, window size, checksum, urgent pointer, option, and the like.

Since details of each field in the IP header, UDP header, and TCP header are well known, detailed description thereof will be omitted here.

In the first embodiment, PCP included in the tag of the header area of the Ethernet frame is used as the protocol assignment information. For example, a smaller value of PCP indicates a higher priority.

A use example of the PCP is shown in FIG. 3. For example, when the value of PCP is 1, it indicates that TCP/IP is used as the upper layer protocol and the protocol is used for a high priority application. When the value of PCP is 2, it indicates that UDP/IP is used as the upper layer protocol and the protocol is used for a high priority application. When the value of PCP is 3, it indicates that TCP/IP or UDP/IP is used as the upper layer protocol and the protocol is used for a low priority application.

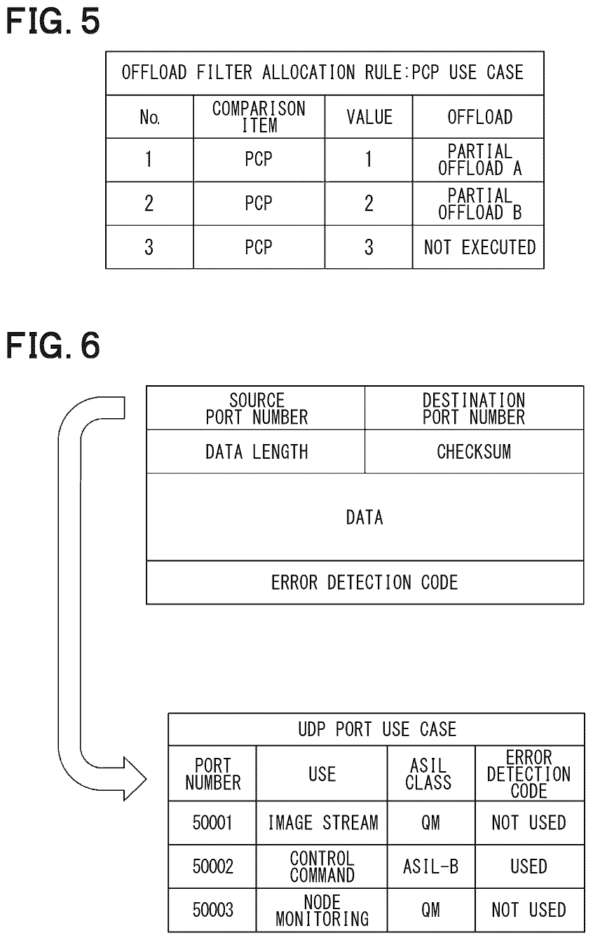

In the above case, allocation rules 521, 551 used in the reception offload filter 52 and the transmission offload filter 55 are set as shown in FIG. 5. The allocation rules 521, 551 are set so that when the value of PCP is 1, the partial offload A is executed (that is, the second reception path R21 or the second transmission path S21 is selected). When the value of PCP is 2, the allocation rule is set to execute the partial offload B (that is, the second reception path R22 or the second transmission path S22 is selected). When the value of PCP is 3, the allocation rule is configured to not execute offloading (that is, the first reception path R1 or the first transmission path S1 is selected).

In the partial offload A, for example, calculation of sequence number, acknowledgment number, and checksum included in the TCP header may be processed using hardware circuit.

In the partial offload B, for example, calculation of checksum included in the UDP header may be processed using hardware circuit.

### 3.2 Second Embodiment

The following will describe a case in which UDP/IP and TCP/IP are used as upper layer protocols, an Ethernet protocol is used as a lower layer protocol, and protocol included in the IP header is used as the protocol assignment information.

In the IP header, protocol is information that identifies a protocol higher than the IP protocol. For example, when a value protocol is 6, the protocol indicates TCP protocol. When a value of protocol is 17, the protocol indicates UDP protocol.

In this case, the allocation rules 521, 551 are set so that when the value of protocol is 6, the partial offload A is executed, and when the value of protocol is 17, the partial offload B is executed. The processing contents of partial offload A and partial offload B are similar to those in the first embodiment.

### 3.3 Third Embodiment

The following will describe a case in which UDP/IP and TCP/IP are used as upper layer protocols, an Ethernet protocol is used as a lower layer protocol, and the port number included in the UDP header is used as the protocol assignment information.

As shown in FIG. 6, the UDP header includes fields for setting source port number, destination port number, data length, and checksum. Depending on the characteristics of data, the UDP payload may include error detection code at the end of data.

In a commonly used method of UDP, the port numbers are assigned according to the purpose and characteristics of the transmission data or reception data. ASIL is known as an index representing the characteristics of transmission data or reception data. ASIL is an abbreviation for Automotive Safety Integrity Level. ASIL is defined in ISO 26262 standard for functional safety of road vehicles, and has four classes identified as A, B, C and D. Class A indicates the lowest safety requirement class, and class D indicates the highest safety requirement level. A level below class A is represented as QM, and QM indicates that the functional safety is not applied. QM is an abbreviation for Quality Management.

FIG. 6 shows a use example of port number using ASIL in UDP.

The port number 50001 is used for transmitting and receiving image streams, and QM is assigned as the ASIL class. The port number 50002 is used for transmitting and receiving control commands, and class B is assigned as the ASIL class. The port number 50003 is used for transmitting and receiving node monitoring frames, and QM is assigned as the ASIL class.

When the ASIL class is A to D, an error detection code for detecting data errors is added to the data area. When the ASIL class is QM, no error detection code is added to the data area.

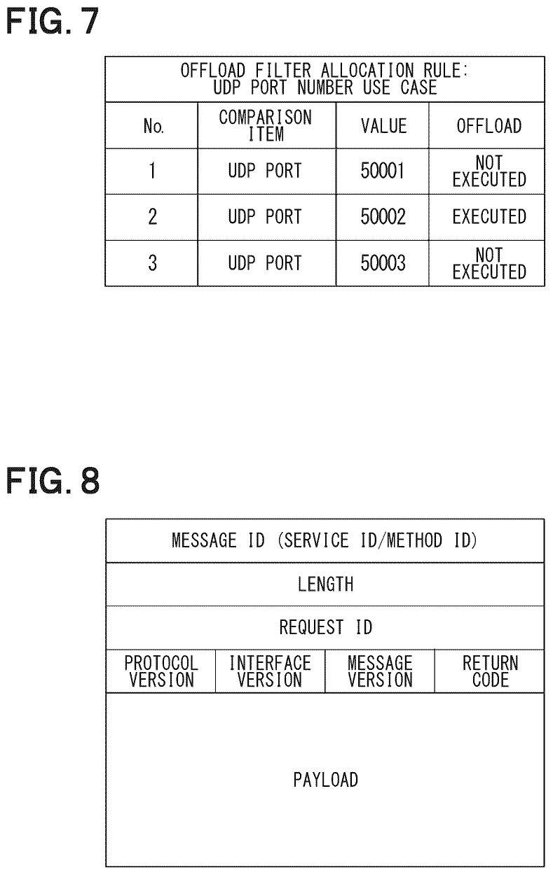

In the above case, as shown in FIG. 7, the allocation rule is set so that when the port number is 50002, offloading is executed, and when the port number is 50001 or 50003, offloading is not executed.

The offload processing unit 53 executes the calculation of error detection code in hardware manner. In the case of processing on the reception path, the offload processing unit 53 may perform, in hardware manner, the process of comparing the calculation result of the error detection code with the error detection code added to the data area of reception data.

### 3.4 Fourth Embodiment

The following will describe a case in which UDP/IP or TCP/IP, and SOME/IP that operates on UDP/IP or TCP/IP are used as upper layer protocols, an Ethernet protocol is used as a lower layer protocol, and information included in the header of SOME/IP frame is used as the protocol assignment information. SOME/IP is an abbreviation for Scalable service-Oriented MiddlewarE over IP.

As shown in FIG. 8, the SOME/IP frame includes fields for setting message ID, length, request ID, protocol version, interface version, message version, return code, in the header of the frame.

The message ID includes a service ID that identifies a service, and a method ID or an event ID that identifies which method or which event of the service identified by the service ID the message relates to.

In the fourth embodiment, the service ID included in the message ID of SOME/IP packet is used as the protocol assignment information. However, SOME/IP is a service-oriented communication, and the upper layer protocol applied in a layer lower than SOME/IP cannot necessarily be uniquely identified from the service ID alone.

Therefore, in the fourth embodiment, for each service ID, application information indicating the upper layer protocol linked to the service ID is transmitted in advance using SOME/IP-SD packet as characteristic information of the transmission data or reception data to be used according to the service ID.

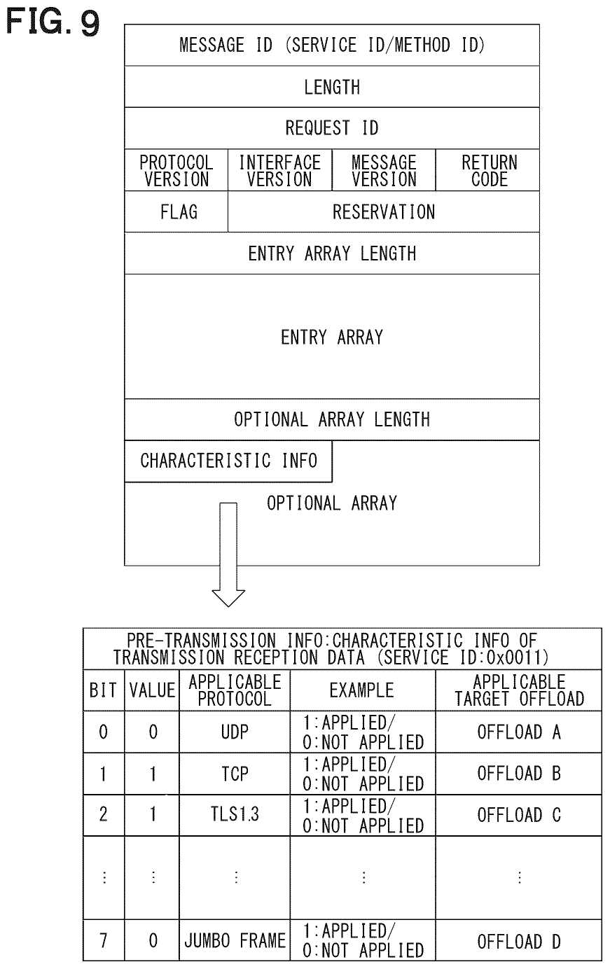

The SOME/IP-SD packet is a packet used to search for available service and establish communication. SD is an abbreviation for Service Discovery. Instead of the payload of SOME/IP packet shown in FIG. 8, the SOME/IP-SD packet shown in FIG. 9 includes fields for setting flag, reservation, entry array length, entry array, optional array length, optional array, and the like. The characteristic information of the transmission data or reception data is set in the optional array and then transmitted or received.

The rule setting application 561 generates the allocation rule 521, 551 using characteristic information of transmission data or reception data received by SOME/IP-SD packet, and distributes the generated allocation rule to the reception offload filter 52 and the transmission offload filter 55. The reception offload filter 52 and the transmission offload filter 55 use the allocation rule 521, 551 distributed from the rule setting application 561 to implement offload processing on the SOME/IP packet basis using the service ID.

The characteristic information of transmission data or reception data is set for each service ID. For example, the characteristic information of transmission data or reception data is composed of 8 bits as shown in FIG. 9, and each bit is assigned with an applicable upper layer protocol used in a layer lower than SOME/IP. For example, bit 0 may be assigned with UDP, bit 1 may be assigned with TCP, bit 2 may be assigned with TLS 1.3, and bit 7 may be assigned with jumbo frame. When each bit has a value of 1, it indicates that the protocol associated with the corresponding bit is to be applied. When the value of each bit is 0, it indicates that the protocol associated with the corresponding bit is not applied. TLS is an abbreviation for Transport Layer Security. TLS is a protocol for performing communication that requires security over computer network such as the Internet. A jumbo frame is an Ethernet frame that has a payload of 1500 bytes or more.

The offload processing is associated with each applicable protocol, and there are offloads A to D. Note that either UDP or TCP is selected exclusively. TLS and jumbo frame may be selected together with another protocol.

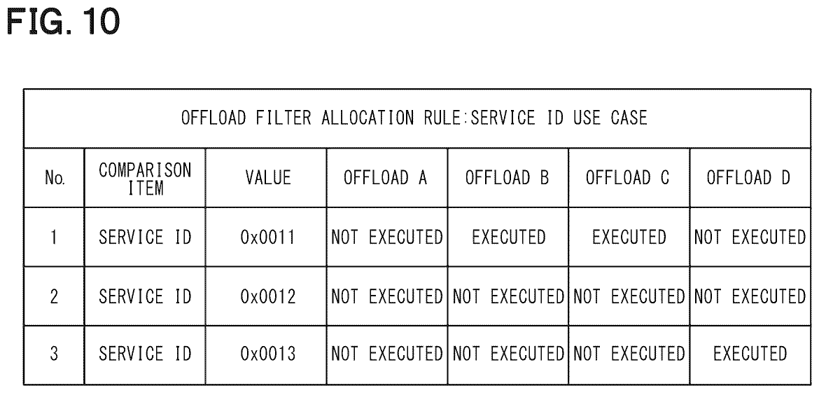

FIG. 10 shows an example of allocation rule 521, 551 generated using characteristic information of transmission data or reception data.

For example, when the service ID is 0x0011, it indicates that offload B associated with TCP and offload C associated with TLS1.3 are to be executed. When the service ID is 0x0012, it indicates that no offloading will be executed. When the service ID is 0x0013, it indicates that only the offload D associated with jumbo frame is to be executed.

In the fourth embodiment, the SOME/IP-SD packet is used to transmit the pre-transmission information, which is characteristic information of transmission data or reception data. The transmission of pre-transmission information is not limited to use of SOME/IP-SD packet. The pre-transmission information may be transmitted using, for example, a data flag sub message used in DDS-RTPS that operates on UDP/IP or TCP/IP. The header of data flag sub message includes a list of QoS parameters used for interpreting the message, and the allocation rule 521, 551 may be set using this information. DDS is an abbreviation for Data Distribution Service. RTPS is an abbreviation for Real-Time Publish-Subscribe Wire Protocol.

### 3.5 Fifth Embodiment

The following will describe a case in which AVTP is used as upper layer protocol, an Ethernet protocol is used as a lower layer protocol, and the information included in the header of AVTP frame is used as the protocol assignment information. AVTP is an abbreviation for AVB Transport Protocol. AVB is an abbreviation for Audio Video Bridging. AVTP is a standard defined under IEEE1722 for transmitting and receiving high-quality audio and video with low delay.

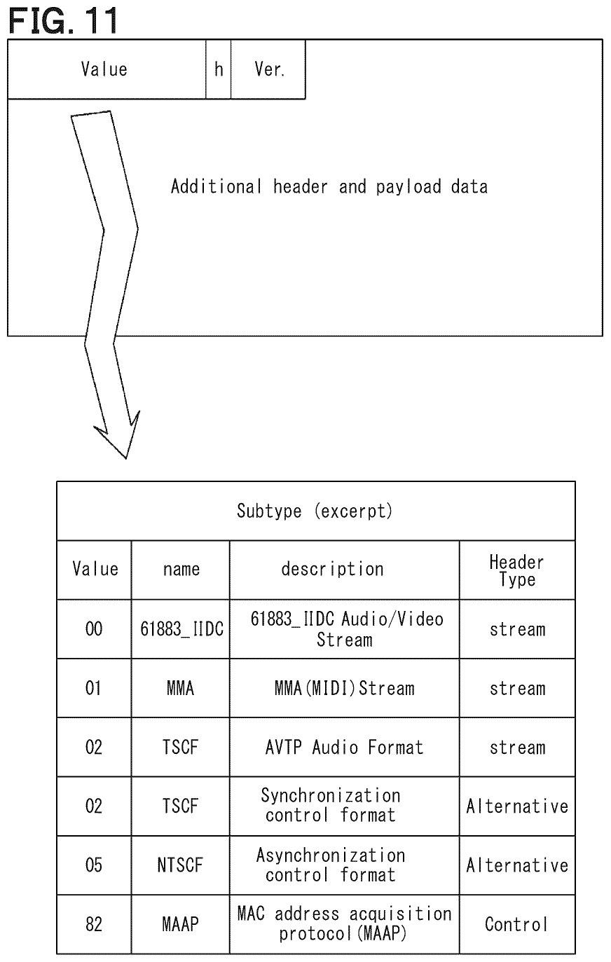

As shown in FIG. 11, the header used when the AVTP frame is used for a stream and control includes fields for setting subtype, header dependent bit, version, and the like.

The subtype indicates the type of transmission data or reception data, and is defined as shown in FIG. 11.

That is, a frame format and a header type are set for each subtype. The allocation rule 521, 551 may be set so that the content of offload processing is changed depending on the value of subtype. In addition, FIG. 11 shows only a part of the subtype.

### 4. Correspondence of Terms

In the present disclosure, the central ECU 2 and the zone ECU 3 connected to the Ethernet transmission line 41, that is, the ECU having the first communication processing unit 22, correspond to a communication device. The rule setting application 561 of the present disclosure corresponds to a rule setting unit.

### 5. Effects

According to the above-described embodiment, the following effects are achieved.

(5a) The in-vehicle system 1includes the reception offload filter 52 and the transmission offload filter 55, each of which refers to the protocol assignment information and determines, in accordance with the allocation rule 521, 551, whether to switch to the offload processing and the type of offload processing. The offload processing executes part or all of the upper layer protocol in hardware manner. Therefore, it is possible to select and execute an appropriate offload processing for each type of upper layer protocol that can be identified from the protocol assignment information. Further, it is possible to select and execute an appropriate offload processing for each type or characteristic of data processed by the upper layer protocol. As a result, the processing load required for software processing of the upper layer protocol can be properly reduced.

(5b) The in-vehicle system 1 is configured to change the allocation rule 521, 551 using the rule setting application 561. Therefore, offload processing can be flexibly optimized in response to various user applications that are added or changed arbitrarily.

(5c) As described in the first embodiment, when PCP included in the header area of Ethernet frame is used as the protocol assignment information, by appropriately linking the PCP with the upper layer protocol, offload processing according to the type of protocol in an upper layer than the Ethernet protocol can be implemented.

(5d) As described in the second embodiment, when the protocol in IP header is used as the protocol assignment information, offload processing can be executed according to the type of protocol in a layer higher than the IP protocol defined in the protocol.

(5e) As described in the third embodiment, when the port number is used as protocol assignment information, the offload filter appropriately links the port number with the type and characteristics of data processed by the port. This configuration enables the offload processing can be executed according to the type and characteristics of data processed by the protocol in a layer higher than UDP and TCP.

(5f) As described in the fourth embodiment, when the service ID included in the message ID of SOME/IP is used as the protocol assignment information, the service ID can be appropriately linked to the applicable upper layer protocol to execute offload processing according to the type of upper layer protocol at a layer lower than SOME/IP.

(5g) As described in the fifth embodiment, when the subtype of AVTP frame is used as the protocol assignment information, offload processing can be executed according to the frame format and header type.

### 6. OTHER EMBODIMENTS

Although the embodiments of the present disclosure have been described above, the present disclosure is not limited to the above embodiments, and various modifications can be made.

(6a) In the above embodiment, the rule setting application 561 is one of the user applications, and sets the offload filter rule. The offload filter rule may be set using a dedicated setting application.

(6b) In the above embodiments, multiple functions of one element may be implemented by multiple elements, or one function of one element may be implemented by multiple elements. Multiple functions of multiple elements may be implemented by one element, one function provided by multiple elements may be implemented by one element. A part of the configuration of the above embodiments may be omitted as appropriate. At least some of the configurations of the above embodiments may be added to or replaced with the configurations of other embodiments.

(6c) In addition to the ECU as the communication device described above, the present disclosure can also be implemented in various forms, such as a system including the communication device as a component, or a method of allocating offload processing.

What is claimed is:

1. A communication device comprising:
a lower layer protocol processing unit executing, in a hardware manner, a processing of a lower layer protocol, the lower layer protocol being a communication protocol including a data link layer;
an upper layer protocol processing unit executing, in a software manner, a processing of an upper layer protocol, the upper layer protocol utilizing the lower layer protocol;
an offload processing unit executing a part or all of the upper layer protocol in a hardware manner instead of the upper layer protocol processing unit; and
a reception offload filter referring to protocol assignment information included in a reception frame received by the lower layer protocol processing unit, and assigning, according to an allocation rule set in advance, the reception frame to a first reception path, which does not use the offload processing unit, or a second reception path, which uses the offload processing unit,
wherein the protocol assignment information is information included in the reception frame and indicates at least one of (i) a type of the upper layer protocol or (ii) a type or characteristics of data to be processed by the upper layer protocol.

2. The communication device according to claim 1, wherein
the lower layer protocol includes an Ethernet protocol, and
a value in a Priority Code Point (PCP) field of a header of Ethernet frame is used as the protocol assignment information.

3. The communication device according to claim 1, wherein
the upper layer protocol includes an Internet Protocol (IP), and
a value in a protocol field of IP header is used as the protocol assignment information.

4. The communication device according to claim 1, wherein
the upper layer protocol includes a User Datagram Protocol (UDP) or Transmission Control Protocol (TCP), and
a value in a destination port number field of UDP header or a value in a destination port number filed of TCP header is used as the protocol assignment information.

5. The communication device according to claim 1, wherein
the upper layer protocol includes a Scalable service-Oriented MiddlewarE over IP (SOME/IP), and
a value in a service identification (ID) field of SOME/IP header is used as the protocol assignment information.

6. The communication device according to claim 1, wherein
the upper layer protocol includes an Audio Video bridging Transport Protocol (AVTP), and
a value in a subtype field of AVTP header is used as the protocol assignment information.

7. The communication device according to claim 1, further comprising
a transmission offload filter referring to the protocol assignment information included in a transmission frame and assigning, according to the allocation rule, transmission data included in the transmission frame to a first transmission path, which does not use the offload processing unit, or a second transmission path, which uses the offload processing unit.

8. The communication device according to claim 1, further comprising
a rule setting unit setting the allocation rule based on pre-transmission information acquired using the upper layer protocol.

9. The communication device according to claim 8, wherein
the rule setting unit acquires the pre-transmission information by using (i) a Scalable service-Oriented MiddlewarE over IP-Service Discovery (SOME/IP-SD) packet or (ii) a data flag sub message of Data Distribution Service-Real-Time Publish-Subscribe Wire Protocol (DDS-RTPS).

10. A communication device comprising:
a circuit unit implemented by hardware circuits; and
a core unit implemented by a central processing unit and a non-transitory tangible storage medium storing a program,
wherein:
the circuit unit executes, in a hardware manner, a processing of a lower layer protocol, and the lower layer protocol is a communication protocol including a data link layer;
the core unit, by executing the program stored in the non-transitory tangible storage medium, is configured to execute, in a software manner, a processing of an upper layer protocol, and the upper layer protocol utilizes the lower layer protocol;
the circuit unit executes a part or all of the upper layer protocol in a hardware manner instead of the core unit as an offload processing;
the circuit unit refers to protocol assignment information included in a reception frame, and assigns, according to an allocation rule set in advance, the reception frame to a first reception path, which does not execute the offload processing, or a second reception path, which executes the offload processing; and
the protocol assignment information is information included in the reception frame and indicates at least one of (i) a type of the upper layer protocol or (ii) a type or characteristics of data to be processed by the upper layer protocol.
